(19) United States
(12) Patent Application Publication
(10) Pub. No.: US 2010/0187813 A1
(43) Pub. Date: Jul. 29, 2010

(54) Connector for Interconnecting A Lateral Pipe to A Main Pipe

(76) Inventor: Richard M. Anders, Port Washington, WI (US)

Correspondence Address: BOYLE FREDRICKSON S.C., 840 North Plankinton Avenue, MILWAUKEE, WI, 53203, US

(21) Appl. No.: 12/358,646

(22) Filed: Jan. 23, 2009

(51) Int. Cl. F16L 41/02; F16L 55/18

(52) U.S. Cl. 285/204; 285/15

(57) ABSTRACT

A one-piece connector has a tubular member and an annular flange, and is usable to connect a lateral pipe to a main pipe. The connector is constructed such that the annular flange is glued to the inner surface of the main pipe and the tubular extends through an opening formed in the main pipe. The connector may be formed of stainless steel or other alloy or of a plastic polymer material. The connector has a tapered end, which is tapered inwardly to facilitate press-fitting a lateral pipe onto the tubular member.

### BACKGROUND OF THE INVENTION

The present invention relates in general to the field of piping and, more particularly, to a connector for connecting a lateral pipe to a main pipe. The present invention is particularly applicable for use with main pipe and lateral pipe rehabilitation.

Buried pipe rehabilitation, whether for rehabilitating a main or supply pipe or a lateral or branch pipe, generally consists of fitting a liner into the pipe having a diameter substantially matched to the inner diameter of the pipe. The liner generally includes an impermeable layer and an adjacent resin-absorbing layer. The resin absorbing layer is soaked with a liquid resin prior to the introduction of the liner into the pipe. After the liner is positioned within the pipe, the liner is pressed against the inner surface of the pipe by fluid pressure. After the liner is pressed against the inner wall of the pipe, the resin is cured which provides structural integrity for the liner.

To connect a lateral pipe to the rehabilitated pipe, an opening is cut into the liner that aligns with either an existing opening in the pipe or a new opening is also cut into the pipe. When securing the lateral pipe to the pipe, heretofore referred to as the “main pipe” to distinguish between the two pipes, it is imperative that a sealed connection be made to prevent the leakage of fluid at the point of interconnection. Moreover, for applications wherein the fluid is maintained at a heightened pressure, a poor sealing between the main pipe and the lateral pipe can lead to fracture and ultimately failure at the connection.

The below-referenced U.S. patents disclose embodiments that were at least in part satisfactory for the purposes for which they were intended. The disclosures of all of the prior United States patents discussed herein are hereby expressly incorporated by reference into the present application in their entireties for purposes including, but not limited to, indicating the background of the present invention and illustrating the state of the art.

U.S. Pat. No. 7,059,638 discloses a self-fastening sewer tap. The device has a flexible flange that is folded toward the inner diameter of the opening to allow insertion of the tap from the outside of the main pipe. After insertion, the flange is then folded back outwards to secure the tap within the main pipe and to provide a seal against the inner surface of the main pipe. A branch pipe is inserted into the end of the tap extending away from the main pipe, pressing against a lip on the inner surface of the tap to create a seal between the branch pipe and the outer surface of the main pipe.

U.S. Pat. No. 6,612,623 discloses a connecting device for joining a pipe with an opening that consists of a sealing member inserted into an opening and against a seat in the desired assembly. Next, an insert member is press-fit into the opening such that it forces the sealing member against the seat of the assembly. Both the sealing member and insert member have a central annular opening through which the connecting pipe may be inserted. The insert member has an annular recess extending around the periphery of the central opening which holds a retaining ring. The retaining ring has teeth pointed toward the assembly and designed to grip the outer surface of a pipe inserted through the insert member and the sealing member.

U.S. Pat. Nos. 6,520,719, 6,068,725, and 5,915,419 disclose a lateral seal for relining pipelines as well as an apparatus or method of making or installing the same. The lateral seal is described as “a floppy top hat” and is constructed of a resin impregnable material and includes a brim portion, which is seated against the inner wall of a main pipe, and a short tubular portion, which extends into the connecting lateral pipe. The two portions of the seal are first connected at the appropriate angle using a template of the main and connecting pipes. The material is impregnated with a resin material and the seal is inserted into the junction between the main and the lateral pipes, the main pipe preferably having been previously relined with a similar resin impregnable material. The resin in the seal is then cured such that the brim portion of the seal is bonded to the previously installed liner and the tubular portion of the seal extends into the connecting lateral pipe providing a seal between the two pipes.

U.S. Pat. No. 6,337,114 discloses a flexible liner resin impregnable for lining a lateral pipe which leads into a main pipe having at one end a flexible collar for installation at the location where the lateral liner meets the main. After installation, the collar extends along the interior of the main seating against the opening of the lateral. The flexible liner is installed by everting the liner through the opening in the collar by means of fluid under pressure supplied to a launching device which is held in position by an inflatable bladder and seals the collar at the lateral main pipe junction.

U.S. Pat. No. 5,927,341 discloses a two-piece sealing member to seal a junction between two pipes. The first piece is generally cylindrical with an outer diameter of the first piece approximately equal to the inner diameter of a main pipe and an aperture extending through the surface of the first piece. The first piece is positioned within the main tube such that the aperture aligns with the lateral connecting point. The second piece includes a collar to overlap the first piece, seated against the inner wall of the main pipe, and a tubular portion to extend into the lateral pipe. Both pieces are made of at least a single layer of resin impregnable material. The point at which the two pieces overlaps bonds together when the resin cures, creating a solid connector between the main and the lateral pipes.

U.S. Pat. Nos. 6,089,615 and 5,957,505 disclose a branch pipe connection for connecting a branch pipe to a main sewer or drainage pipe.

U.S. Pat. No. 4,637,638 discloses a branched hose construction having a connector that includes a flange portion designed to engage the inner wall of a first hose. A tubular portion extends through a hole in the first hose and engages a second hose. The connector further includes a washer-like member extending over the tubular portion of the connector and engaging the outer wall of the first hose. The washer-like member and the flange portion of the connector act as a clamp to seal the hole through the first hose. The second hose is inserted over the tubular portion of the connector, and an annular clamping device holds the second hose to the tubular portion of the connector.

U.S. Pat. No. 4,123,093 discloses a collar for connecting conduits to ductboard. The collar is generally tubular in construction. A first opening on the first end of the collar includes a tapered end for connection with another duct. The second end of the collar has a radial bead, spaced away from the end and arranged such that the bead is seated against the outer surface of the ductboard and the collar extends through an opening in the ductboard. The collar further includes spring clips to secure the collar to the ductboard.

U.S. Publ. No. 2004/0016467 discloses a method of repairing a junction between a main and a lateral pipe by forming a fiber seal using a mold which replicates the junction between the main and the lateral pipes. The fiber seal is woven together such that it creates a seamless, single-member seal. The fiber seal is then impregnated with resin. Finally, the seal is cured in place to create a seal between the main and the lateral pipes.

While satisfactorily effective, there remains a need to improve the structural integrity at the interconnection between the main pipe and the lateral pipe. That is, many of the known connectors consist of multiple components that must be joined together, such as by curing resin. Other types of connectors have an everted member that may create a pinch point that may be structurally unstable in some high pressure applications.

### SUMMARY AND OBJECTS OF THE INVENTION

In one embodiment the present invention is directed to a one-piece connector having a tubular member and an annular flange, and usable to connect a lateral pipe to a main pipe. The connector is constructed such that the annular flange is attached preferably by gluing to the inner surface of the main pipe and the tubular member extends through an opening formed in the main pipe. In one embodiment, the connector is formed of stainless steel or other alloy. Alternately, the connector may be formed of a plastic polymer material. Preferably, the connector is not cured after it is installed in the main pipe.

The tubular member extends from the annular flange to a tapered end, which is preferably tapered inwardly at approximately 5.0 degrees. The taper is designed to facilitate easier press-fitting of a lateral pipe onto the tubular member. In one preferred embodiment, the taper end is formed in the last 0.13 inches of the tubular member.

The annular flange is preferably approximately 0.09 inches thick and has an outer diameter of approximately 2.32 inches. In one preferred installation process, the flange is pressed against the inner surface of the main pipe at approximately 150 psi. The flange thus engages the inner surface of the main pipe to provide a mechanical locking therebetween. In addition, glue or similar bonding adhesive is present on the flange, or portions thereof, before the flange is pressed into engagement with the inner surface of the main pipe. In this regard, the flange is mechanically coupled but also adhesively coupled to the main pipe. The adhesive is preferably selected form a group of anaerobic adhesives. The adhesive is designed to assist in holding the flange in place against the inner surface of the main pipe but also act as a sealant or gasket to prevent fluid from leaking at the interconnection of the main and lateral pipes. In addition, adhesive may be applied to the tubular member to assist with the coupling of the lateral pipe to the tubular member.

It is therefore an object of the invention to provide a connector for interconnecting a lateral pipe to a main pipe or other pipe.

It is a further object of the invention to provide a one-piece connector formed of stainless steel or similar alloy or plastic polymer material that provides a structurally strong interconnection between pipes.

It is a yet a further object of the invention to use a bonding agent to secure the connector in place that also provides a sealant against fluid leakage.

These and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 is an isometric view of a main pipe and lateral pipe interconnected using a connector according to one embodiment of the present invention;

FIG. 2 is an isometric view of the connector according to one embodiment of the invention;

FIG. 3 is a side elevation view of the connector shown in FIG. 2;

FIG. 4 is a section view taken along line 4-4 of FIG. 1;

FIG. 5 is a side elevation view of a connector according to another embodiment of the invention; and

FIG. 6 is side section view of a rehabilitated pipe.

In describing the preferred embodiment of the invention, which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the word “connected”, “attached”, or terms similar thereto are used. They are not limited to direct connection but include connection through other elements where such connection is recognized as being equivalent by those skilled in the art.

### DETAILED DESCRIPTION

The present invention and the various features and advantageous details thereof are explained more fully with reference to the non-limiting embodiments described in detail in the following description.

The present invention will be described with respect to the interconnection between two pipes in which the pipes are arranged generally orthogonal to one another. Therefore, for purposes of explanation, one pipe will be referred to as a main pipe and the connecting pipe will be referred to as a lateral pipe. It is understood that fluid flow not be necessarily from the main pipe to the lateral pipe. In this regard, it is contemplated that fluid may flow into the main pipe from the lateral pipe or vice-versa. Thus, it shall be appreciated that the terms “main” and “lateral” are used to reflect the orientation of the pipes rather than any relative functional importance between the pipes in a fluid system. In addition, in one preferred implementation, the invention is used to connect rehabilitated pipes to one another, but it is understood that the invention is not so limited.

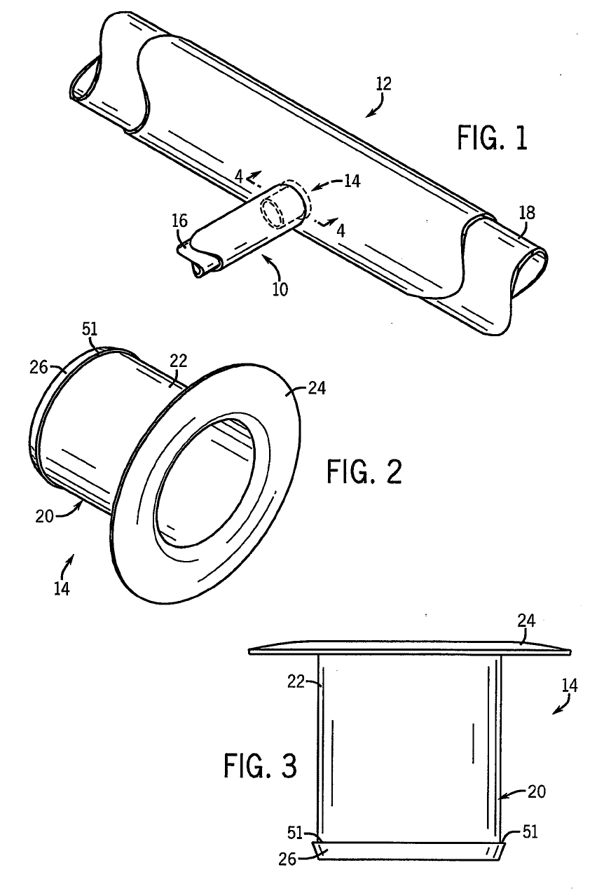

Referring now to FIG. 1, a lateral pipe 10 is shown fluidly coupled to a main pipe 12. A connector 14 interconnects the lateral pipe 10 and the main pipe 12, as will be described more fully below. In the illustrated example, the lateral pipe 10 and the main pipe 12 have been rehabilitated and thus include a liner 16 and 18, respectively. The liners 16, 18 may be put in place in a conventional manner. For example, in one preferred embodiment, the liners 16, 18 are impregnated with a resin that when cures bonds the liner to the inner walls of the its respective pipe. It should be noted that while a liner is shown in the lateral pipe, it is typical that there is no liner in such a lateral pipe, particularly if the diameter is only a few inches wide. Further, it should be noted that lateral may be replaced by a shut off valve in some applications.

One known liner installation process uses highly pressured air passed through the pipes to force the liners against the inner walls of the pipes. When a curing agent, such as heated water, is then passed through the pipes, the resin will cure and bond the liners to the inner walls of the pipes. It is understood that other types of rehabilitation techniques and devices may be used. Moreover, it is understood that the connector 14 may be used to connect non-rehabilitated pipes, or non-rehabilitated portions of otherwise rehabilitated pipes. Further, it is understood that the invention may be used to connect a rehabilitated pipe with a non-rehabilitated pipe. Also, it is understood that the invention may be used with liners of various constructions. One exemplary liner construction is disclosed in U.S. Pub. No. 2008/0277012, the disclosure of which is incorporated herein.

In the illustrated example, the lateral pipe 10 extends from the main pipe 12 at a generally right angle. However, it is understood that the connector 14 may be constructed such that the lateral pipe 10 is at an acute or obtuse angle relative to the main pipe 12.

With additional reference to FIGS. 2 and 3, the connector 14 has an elongated and hollow tubular body 20 defined by annular wall 22. An annular flange 24 is formed at one end of the tubular body 20 and a tapered edge 26 is formed at the opposite end. In one exemplary embodiment, the length of the tubular body 20 together with the tapered edge 26 is approximately 1.50 inches, the tapered edge 26 has a length of approximately 0.13 inches, and the tapered edge tapers inwardly at a slope of approximately 5.0 degrees. In this exemplary embodiment, the thickness of the annular wall 22 is 0.03 inches and the thickness of the annular flange 24 is 0.09 inches. The outer diameter of the tubular body 20 is preferably 1.315 inches and the outer diameter of the annular flange 24 is preferably 2.32 inches. In one preferred embodiment, the tapered edge 26 extends about 0.03 inches from the outer portion of the annular wall 22 as shown in FIG. 3 to act as a catch or barb 51 to prevent removal. It is understood that the above-recited dimensions are merely examples and that a connector having different dimensions is within the scope of the invention.

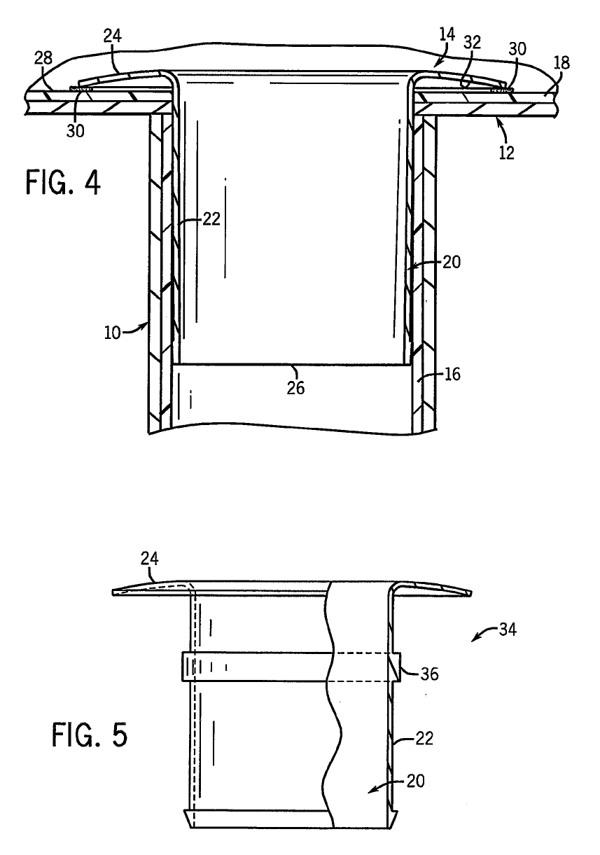

Referring now to FIG. 4, a section view taken along line 4-4 of FIG. 1 shows how the connector 14 of the present invention may be used to interconnect lateral pipe 10 and main pipe 12. It will be appreciated that an opening must first be formed in the main pipe 12. Preferably, the opening is formed to have a diameter that is slightly larger than the diameter of the tubular body 20 of the connector 14. The opening may be formed in any one of a number of conventional ways.

The connector 14 is designed such that the tubular body 20 extends through the opening and the annular flange 24 is held against the inner annular surface 28 of the liner 18. For a non-rehabilitated pipe, the annular flange 24 would be held directly against the inner annular surface of the main pipe 12. To assist with the connection of the flange 24 to the liner 18 and thus the connection of the connector 14 to the main pipe 12, a bonding adhesive 30 is placed on the backside 32 of the flange 24 such that when the flange 24 is pressed against the liner 18 (or main pipe 12) the flange 24 will be glued in place to the liner 18. Preferably, an anaerobic adhesive 30 is used, but it is understood that other types of adhesives, epoxies, glues, and the like may be used. In addition to assisting with the securing the flange 24 to the liner 18, the adhesive also provides a seal or gasket against leakage at the opening.

The tubular body 20 is adapted to engage an end portion of the lateral pipe 10. Preferably, the diameter of the lateral pipe 10 is slightly more than outer diameter of the tubular body 20 so that a snug fitting between the tubular body 20 and the lateral pipe 10 is made. The narrowed diameter of the tubular body 20 provided by the inwardly tapered edge 26 eases the sliding of the lateral pipe 10 onto the tubular body 20.

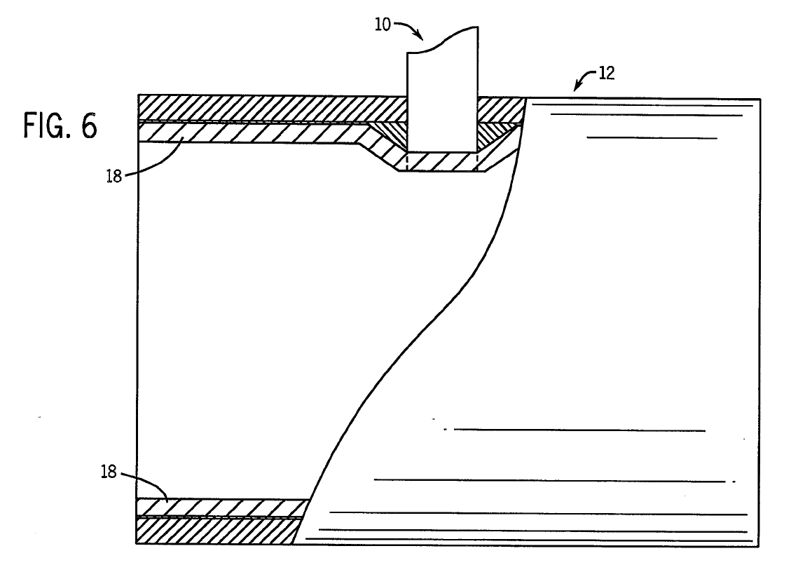

As shown in FIG. 6, the main pipe 12 is preferably rehabilitated as shown. As the lateral's opening is covered over by the liner 18 soaked with resin during rehabilitation of the main pipe, a hole must be tapped through the liner to create a channel through to lateral. This hole is preferably cut by a remotely-controlled robotic device (not shown) from inside the main pipe. It will thus be appreciated that the connector 14 is designed to be loaded into place also from within the main pipe 12.

In a preferred embodiment, the connector 14 is held by a robotic device (not shown) that is placed within the main pipe 12 and translated along the length of the main pipe 12 in a conventional manner until generally adjacent a lateral opening in the main pipe 12. Preferably, the aforedescribed adhesive is applied onto the flange 24 before the robotic device is translated within the main pipe 12, but it is understood that the robotic device or other remote controlled device may be capable of applying the adhesive 30 at the use site. With the adhesive 30 applied, the tubular body 20 is aligned with and then passed through the opening until the flange 24 engages the inner surface 28 of the liner 18 (or the main pipe 12). It is also contemplated that the adhesive 30 could be applied to the liner 18 proximate the opening instead of or in addition to the adhesive 30 applied to the flange 24. In a preferred embodiment, the flange 24 is pressed against the inner surface 28 under a relatively high pressure, such as 150 psi. In another preferred embodiment, only about 50 psi of pressure may be needed. Preferably, the connector 14 is pressed into place such that portions of the flange 24 conform to the curvature of the inner surface 28 and thus mechanically engage the inner surface 28. In this regard, a mechanical as well as a chemical bond is formed between the connector 14 and the main pipe 12.

Once the adhesive has cured, a lateral pipe 10 may then be placed over the tubular body 20. In one preferred installation process, the pressure on the connector 14 by the robotic device is maintained as the lateral pipe 10 is installed to prevent any breaking away of the connector 14 from the main pipe 12. It is also understood that adhesive may also be placed on the tubular body to assist with the coupling between the connector and the main pipe as well as the lateral pipe.

FIG. 5 illustrates a connector 34 according to another embodiment of the invention. In this alternate embodiment, the connector 34 is similar in construction to the connector 14 previously described, but includes an additional annular ring 36 formed circumferentially around the tubular body 20. The annular ring 36 is operative as a catch when a flexible hose or tube is connected as a lateral to the main pipe 12 and thus helps prevent the lateral from sliding off of the tubular body 20. In one embodiment, the ring 36 may also be tapered like flange 26 (not shown) to act as a barb. More particularly, when a lateral hose is slid onto the tubular body, to complete the installation, the lateral hose must be pulled over the annular ring 36. The lateral hose may then be clamped in a known manner to the tubular body 20 of the connector 14. It should be noted that in this embodiment there is no barb on the flange although one may present.

The position of the annular ring 36 shown in FIG. 5 is merely an example and it is understood that the annular ring 36 may be placed at different positions along the tubular body 20 than that shown in the figure. In addition, multiple annular rings may be formed on the tubular body 20.

In a preferred embodiment, the connector 14 (as well as connector 34) is formed of a rust-resistant metal alloy such as 304 or 316 stainless steel. However, it is understood that other alloys may be used as well as non-metal materials, such as a plastic polymer material. Further, while a number of different adhesives may be used, in a preferred embodiment, the adhesive is hydrophilic adhesive that expands slightly when wet to not only provide adhesion but also a seal._. It should be noted that the adhesive is used to generally provide more of a chemical coupling (about 50%) while the flange 26 provides more of a mechanical coupling (about 50%).

In a preferred embodiment, the connector is formed of a one-piece unitary construction using any of a number of known fabrication processes such as injection molding, casting, forging, and the like.

The individual components described herein need not necessarily be formed in the disclosed shapes, or assembled in the disclosed configuration, but could be provided in virtually any shape, and assembled in virtually any configuration. Furthermore, all the disclosed features of each disclosed embodiment can be combined with, or substituted for, the disclosed features of every other disclosed embodiment except where such features are mutually exclusive.

Although the best mode contemplated by the inventors of carrying out the present invention is disclosed above, practice of the present invention is not limited thereto. It will be manifest that various additions, modifications and rearrangements of the features of the present invention may be made without deviating from the spirit and scope of the underlying inventive concept.

It is intended that the appended claims cover all such additions, modifications and rearrangements. Expedient embodiments of the present invention are differentiated by the appended claims.

What is claimed is:

1. An apparatus for interconnecting a lateral pipe and a main pipe, comprising:
a hollow body having a first end and a second end opposite the first end, wherein the hollow body provides a conduit along which fluid may flow and the first end provides an inlet to the conduit and the second end provide an outlet from the conduit;
a flange extending generally axially from the first end and having a first surface and a second surface opposite the first surface, and wherein the second surface is adapted to fit against the inner wall of the main pipe and wherein the second end is adapted to snuggly receive the lateral pipe; and
a bonding agent adapted to seal the second surface to the inner wall of the main pipe.

2. The apparatus of claim 1 wherein the hollow body and the flange are formed of a metal.

3. The apparatus of claim 2 wherein the metal is stainless steel.

4. The apparatus of claim 1 wherein the hollow body has an annular wall having an inner diameter and an outer diameter, and the flange is in the form of annular ring extending axially from the outer diameter of the first end.

5. The apparatus of claim 4 wherein the inner diameter is generally constant between the first end and the second end.

6. The apparatus of claim 1 wherein the second end of the hollow body has a tapered portion.

7. The apparatus of claim 6 wherein the tapered portion is formed in the annular wall and is tapered toward the inner diameter.

8. The apparatus of claim 7 wherein the tapered portion tapers at an angle of approximately 5.0 degrees.

9. The apparatus of claim 6 wherein the tapered portion has a length of approximately 0.13 inches.

10. The apparatus of claim 5 wherein the annular wall has a thickness of approximately 0.03 inches.

11. The apparatus of claim 1 wherein the hollow body has a length of 1.50 inches between the first end and the second end.

12. The apparatus of claim 1 wherein the bonding agent includes a hydrophilic adhesive.

13. The apparatus of claim 1 further comprising an annular ring extending axially from the hollow body between the flange and the second end.

14. A liner system for interconnecting a main pipe and a lateral pipe, comprising:
a first tubular member adapted to be fitted into a main pipe, wherein an opening is formed in the first tubular member and is aligned in an opening formed in the main pipe;
a connector adapted to extend through the openings and be adhesively sealed to the main pipe; and
a second tubular member adapted to be fitted into the lateral pipe and snugly fit over a portion of the connector extending through the openings.

15. The liner system of claim 14 wherein the connector has an annular flange adapted to be sealed to an inner wall of the main pipe.

16. The liner system of claim 14 wherein the connector has a one-piece construction.

17. The liner system of claim 14 wherein the connector is made of a rust-resistant material.

18. The liner system of claim 14 wherein the connector has a tapered end that is received by the lateral pipe.

19. A method of interconnecting a main pipe and a lateral pipe, comprising:
forming an opening in a wall of the main pipe;
aligning a connector with the opening, wherein the connector has a generally tubular body and an annular flange formed at one end of the tubular body;
partially passing the connector through the opening;
sealing the flange to the wall of the main pipe; and
fitting an end of the lateral pipe over that portion of the tubular body extending through the opening in the main pipe.

20. The method of claim 19, wherein all of the steps after the forming step are preformed by a remotely controlled robotic device.
